(19) United States
(12) Patent Application Publication
(10) Pub. No.: US 2016/0349048 A1
(43) Pub. Date: Dec. 1, 2016

(54) LEVELING DEVICE

(71) Applicants: Angelo Rodriguez, Tempe, AZ (US); Dan Martinko, Lake In The Hills, IL (US)

(72) Inventors: Angelo Rodriguez, Tempe, AZ (US); Dan Martinko, Lake In The Hills, IL (US)

(21) Appl. No.: 15/169,644

(22) Filed: May 31, 2016

Related U.S. Application Data
(60) Provisional application No. 62/168,028, filed on May 29, 2015.

(51) Int. Cl. G01C 9/28; G01C 9/34

(52) U.S. Cl. CPC G01C 9/28; G01C 9/34

(57) ABSTRACT

A leveling device providing a hands free means of determining measurements and leveling standards is provided. The leveling device comprises an elongated tool having a first end, a second end opposite thefirst end, a top surface, and a bottom surface opposite the top surface. At least one level is mounted to the elongated tool. A plurality of independently activatable, spring-loaded leveling buttons is mounted in the bottom surface of the tool. Upon being in a retracted position, each of the leveling buttons is flush with the bottom surface of the tool and upon being released from the retracted position into an extended position, each leveling button extends a unique predetermined distance from the bottom surface of the tool.

### CLAIM OF PRIORITY

This patent application claims priority under 35 USC 119 (e) (1) from U.S. Provisional Patent Application Ser. No. 62/168,028 filed May 29, 2015, of common inventorship herewith entitled, “D and A Level,” which is incorporated herein by reference as though the same were set forth in its entirety.

### FIELD OF THE INVENTION

The present invention pertains to the field of construction tools, and more specifically to the field of leveling devices.

### BACKGROUND OF THE INVENTION

The vast majority of home improvement or repair jobs are impractical and virtually impossible to complete without proper tools. It is a common occurrence to find a fully stocked tool box or chest in the garages, sheds, and utility closets of many homeowners. Along with screwdrivers, wrenches, and pliers, a staple included within many tool boxes is a leveling instrument.

The purpose of the level is to ascertain whether a surface is horizontal, vertical, or at a forty five degree angle. Consisting essentially of an encased, liquid filled tube containing an air bubble that moves to a center window when the instrument is set on an even plane, this instrument measures true horizontal level, and true vertical plumb. The tube or vial is incorporated into rails of wood, plastic, aluminum or magnesium available in solid, I beam or box beam. Helping to ensure straight, even placements and level smooth edges, the level is an essential tool in many home improvement projects, providing physical verification the job is done right.

The prior art has put forth several designs for leveling devices. Among these are:

U.S. Pat. No. 7,779,545 to Gabriel Kallabis describes a spirit level including a base body in the form of a hollow profile as well as a bubble level vial formed of a vial body with an enclosed cavity preferably of barrel shape. The vial is secured in a base body by means of a holder. The cavity contains a liquid with gas bubbles floating therein and the vial body has end face regions running transversely to the lengthwise axis of the cavity. To achieve a high contrast between the end of the bubble and the liquid, it is proposed that the vial body be joined to the holder by an intimate material connection in the at least one end face region. The holder and the intimate material connection is contrast intensifying in the region of the at least one end face region.

U.S. Pat. No. 4,467,527 to Bryant R. Gold, Larry North describes a digital level that includes a digital display for displaying the angle of inclination between a straight edge of a digital level and a desired reference plane. An alarm is included to indicate whenever the digital level is held parallel to a desired reference plane, such as a level horizontal plane or a vertical plane. The level transducer employed within the digital level includes a rotating member that is weighted so as to always be aligned with a gravitational field in which the level is used. The body of the level includes flip up sights so it is readily used as a transit. A micro switch located on the underneath side of the level automatically powers the circuitry used in connection with the sensing circuitry and digital display whenever the level is placed on a planar surface.

U.S. Pat. No. 2,827,558 to George C Lents describes an illuminated graduated level which includes a manually operable illuminated dial that is manually movable to permit a user to accurately ascertain the pitch of a wall or other object. Another object of the invention is to provide an illuminated level for use by carpenters, bricklayers or other persons wherein there is positioned within the body of the tool a battery and light bulb as well as an indicating means so the user can adjust the level in order to determine the angular position or pitch of any object desired. A further object of the invention is to provide an illuminated graduated level which is extremely simple and inexpensive to manufacture.

None of these prior art references describe the present invention.

### SUMMARY OF THE INVENTION

It is an object of the present invention to provide an improved leveling device that provides a hands free means of determining measurements and leveling standards.

The present invention is a leveling device providing a hands free means of determining measurements and leveling standards. The leveling device comprises an elongated tool having a first end, a second end opposite the first end, a top surface, and a bottom surface opposite the top surface. At least one bubble level is mounted to the elongated tool. A plurality of independently activatable, spring-loaded leveling buttons is mounted in the bottom surface of the tool. Upon being in a retracted position, each of the leveling buttons is flush with the bottom surface of the tool and upon being released from the retracted position into an extended position, each leveling button extends a unique predetermined distance from the bottom surface of the tool.

In addition, the present invention includes a method for providing a hands free means of determining measurements and leveling standards. The method comprises providing an elongated tool having a first end, a second end opposite the first end, a top surface, and a bottom surface opposite the top surface, mounting at least one level to the elongated tool, mounting a plurality of independently activatable, spring-loaded leveling buttons in the bottom surface of the tool and flush with the bottom surface of the tool, releasing the leveling buttons from a retracted position into an extended position, and extending each leveling button a unique predetermined distance from the bottom surface of the tool.

The present invention further includes a leveling device providing a hands free means of determining measurements and leveling standards. The leveling device comprises an elongated tool having a first end, a second end opposite the first end, a top surface, and a bottom surface opposite the top surface. Three bubble levels are mounted to the elongated tool, each bubble level measuring a different level angle. A plurality of independently activatable, spring-loaded leveling buttons is mounted in the bottom surface of the tool. Upon being in a retracted position, each of the leveling buttons is flush with the bottom surface of the tool. Each of the leveling buttons is released upon applying pressure to each leveling button and each of the leveling buttons is returned to the retracted position upon applying pressure to each released leveling button. Upon being released from the retracted position into an extended position, each leveling button extends a unique predetermined distance from the bottom surface of the tool.

### BRIEF DESCRIPTION OF THE DRAWINGS

FIG. 1 is an elevational front view illustrating a leveling device, constructed in accordance with the present invention, showing horizontal, vertical and forty five degree leveling capabilities.

FIG. 2 is a perspective view illustrating the leveling device, constructed in accordance with the present invention, with three operating buttons that a user presses respectively to achieve horizontal, vertical, and forty five degree levelness on a surface being measured for potential outages.

FIG. 3 is an elevational front view illustrating the leveling device, constructed in accordance with the present invention, with six operating buttons that a user presses respectively to achieve horizontal, vertical, and forty five degree levelness on a surface being measured for potential outages.

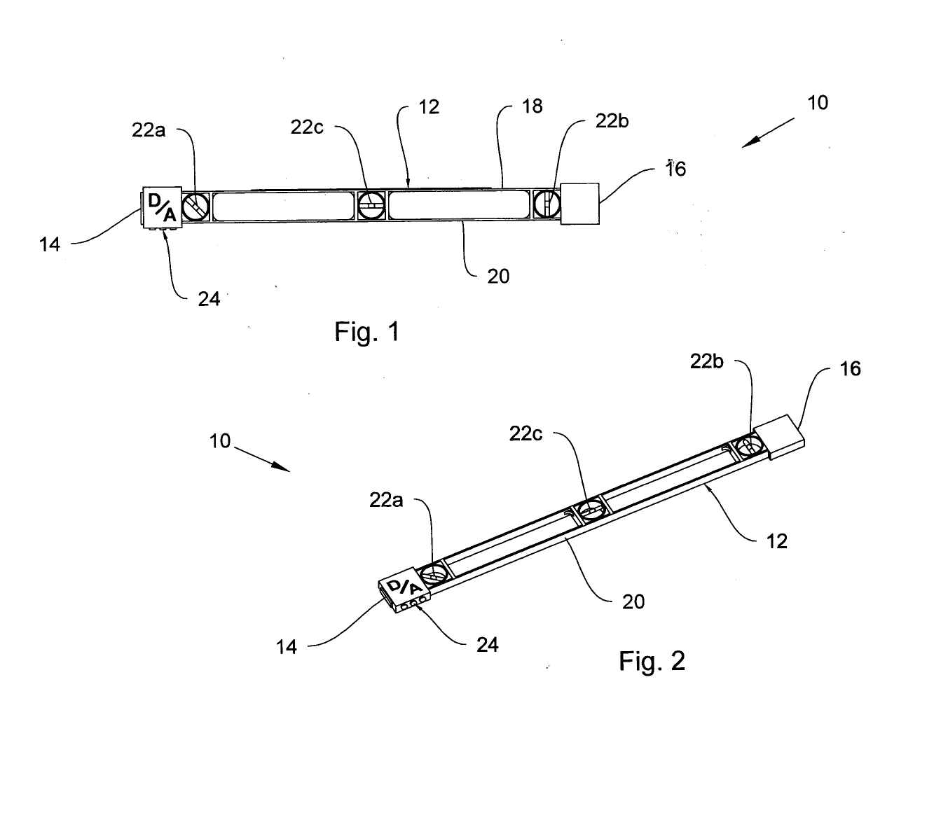

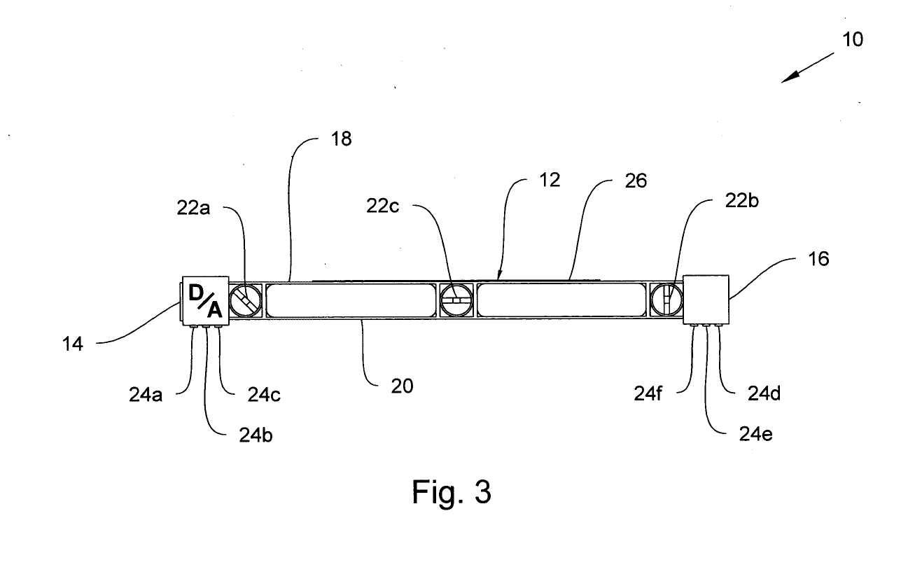

### DETAILED DESCRIPTION OF THE INVENTION

The present invention, hereinafter referred to as a Leveling Device, indicated generally at 10, is an improved leveling device that provides a hands free means of determining measurements and leveling standards. The Leveling Device 10 of the present invention incorporates a mechanism that gives the user accurate readings or outages. In addition to indicating levelness, the Leveling Device 10 eliminates the need to wrestle with tape measures, shims or any other additional tools to determine the amount of outage.

The Leveling Device 10 of the present invention is an elongated, substantially rectangular tool 12 having a first end 14, a second end 16 opposite the first end 14, a top surface 18, and a bottom surface 20 opposite the top surface 18. The tool 12 preferably has three levels 22 mounted therein. Preferably, the levels 22 are bubble levels with the first bubble level 22a mounted adjacent the first end 14 of the tool 12, the second bubble level 22b mounted adjacent the second end 16 of the tool 12, and the third bubble level 22c mounted in the middle of the tool 12 approximately equal distance between the first end 14 and the second end 16 of the tool 12. In addition, preferably, the first bubble level 22a is a forty-five degree level, the second bubble level 22b is a vertical level, and the third bubble level 22c is a horizontal bubble level. While the bubble levels 22 have been described as measuring certain angles, it is within the scope of the present invention for the bubble levels 22 to measure different levels than those described and illustrated herein.

The Leveling Device 10 of the present invention further includes a plurality of independently operated, spring-loaded leveling buttons 24 mounted in the bottom surface of the tool. When in a retracted position, each of the leveling buttons 24 is flush with the bottom surface 20 of the tool 12. Upon pressing of each of the leveling buttons 24, the leveling buttons 24 are released into an extended position and extend a predetermined distance from the bottom surface 20 of the tool 12. Upon pressing of each leveling button 24 again, the leveling buttons 24 are returned to the retracted position flush with the bottom surface 20 of the tool 12.

In a preferred embodiment, the tool 12 of the Leveling Device 10 of the present invention includes six (6) leveling buttons 24 with three (3) leveling buttons 24a, 24b, 24c mounted nearingly adjacent the first end 14 of the tool 12 and three (3) leveling buttons 24d, 24e24f, mounted nearingly adjacent the second end 16 of the tool 12. In the extended position, the three (3) leveling buttons 24a, 24b, 24c adjacent the first end 14 of the tool 12 have a length of one-eighth (⅛″ ) inch, one-quarter (¼″ ) inch, and one-half (½″ ) inch, respectively. In addition, in the extended position, the three (3) leveling buttons 24d, 24e, 24f adjacent the second end 16 of the tool 12 have a length of three-sixteenths ( 3/16″ ) inch, five-sixteenths ( 5/16″ ) inch, and seven-sixteenths ( 7/16″ ) inch, respectively. Each of the levelin buttons 24 are independently activatable to determine the outage of a surface, as will be described in further detail below.

The tool 12 of the Leveling Device 10 is preferably constructed from a durable plastic material. Rectangular in shape, the tool 12 measures approximately two (2′) feet in length, two and one-quarter (2¼″ ) inches in height, and one (1″) inch in width. The top surface 18 or the bottom surface 20 of the tool 12 of the Leveling Device 10 preferably includes a length of magnetic strip 26 to facilitate releasable securement and placement of the tool 12 during use. Although the present invention is described with respect to a two foot level, it is also contemplated that it is useful for any length of level, including four foot and six foot levels.

Use of the Leveling Device 10 of the present invention is simple and straightforward. A user positions the bottom surface 20 of the tool 12 against the surface being tested for levelness. If the observed bubble level 22 indicates that the surface is not level, the user removes the tool 12 from the tested surface, releases one leveling button 24 from the retracted position to the extended position, again positions the tool 12 against the tested surface, and observes the bubble level 22. If the tool 12 now indicates levelness of the surface, then the user knows exactly how much to move or shim the tested surface. If not, the user repeats the steps with a different leveling button 24 until it is determined how much adjustment is required. As set forth above, the first end 14 of the tool 12 provides readings of approximately one-eighth (⅛″ ) inch, one-quarter (¼″ ) inch, and one-half (½″ ) inch and the second end 16 of the tool 12 provides readings of approximately three-sixteenths ( 3/16″ ) inch, five-sixteenths ( 5/16″ ) inch, and seven-sixteenths ( 7/16″ ) inch.

The Leveling Device 10 of the present invention provides a more user friendly means of achieving straight, accurate planes in virtually any leveling job. A tool 12 that is specially configured with a measuring component that instantly provides outage readings, the Leveling Device 10 provides users with an easily viewable indication that a surface is perfectly leveled. The Leveling Device 10 eliminates any need to rely on externals such as tape measures and shims to measure the outage of the surface that are challenging to manage. Once placed on a surface, the Leveling Device 10 of the present invention is hands free and takes any guesswork out of leveling and measuring jobs. Saving valuable time, the Leveling Device 10 enables professionals to complete jobs accurately and expediently. While the Leveling Device 10 of the present invention primarily is configured for professional contractors, glaziers, electricians, plumbers, and carpenters, the Leveling Device 10 is a highly functional and effective tool 12 employed by both experienced and inexperienced do it yourselfers at home. Made of durable, high quality materials, the Leveling Device 10 will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A leveling device providing a hands free means of determining measurements and leveling standards, the leveling device comprising:
an elongated tool having a first end, a second end opposite the first end, a top surface, and a bottom surface opposite the top surface;
at least one level mounted to the elongated tool; and
a plurality of independently activatable, spring-loaded leveling buttons mounted in the bottom surface of the tool;
wherein upon being in a retracted position, each of the leveling buttons is flush with the bottom surface of the tool; and
wherein upon being released from the retracted position into an extended. position, each leveling button extends a unique predetermined distance from the bottom surface of the tool.

2. The leveling device of claim 1 wherein the tool is substantially rectangular.

3. The leveling device of claim 1 wherein the at least one level is a bubble level and further comprising:
three bubble levels mounted to the elongated tool.

4. The leveling device of claim 3 and further comprising:
a first bubble level mounted adjacent the first end of the tool;
a second bubble level mounted adjacent the second end of the tool; and
a third bubble level mounted in the middle of the tool approximately equal distance between the first end and the second end of the tool.

5. The leveling device of claim 4 wherein the first bubble level is a forty-five degree level, the second bubble level is a vertical level, and the third bubble level is a horizontal bubble level.

6. The leveling device of claim 1 wherein each leveling button is released upon applying pressure to each leveling button.

7. The leveling device of claim 6 wherein each released leveling button is returned to the retracted position upon applying pressure to each released leveling button.

8. The leveling device of claim 1 and further comprising:
three (3) first end leveling buttons mounted nearingly adjacent the first end of the tool; and
three (3) second end leveling buttons mounted nearingly adjacent the second end of the tool.

9. The leveling device of claim 8 wherein upon releasing the first end leveling buttons into the extended position, the three (3) first end leveling buttons adjacent the first end of the tool have a length of one-eighth (⅛″ ) inch, one-quarter (¼″ ) inch, and one-half (½″ ) inch, respectively.

10. The leveling device of claim 8 wherein upon releasing the second end leveling buttons into the extended position, the three (3) second end leveling buttons adjacent the second end of the tool have a length of three-sixteenths ( 3/16″ ) inch, five-sixteenths ( 5/16″ ) inch, and seven-sixteenths ( 7/16″ ) inch, respectively.

11. The leveling device of claim 1 wherein the tool is constructed from a plastic material and measures approximately two (2′) feet in length, two and one-quarter (2¼″ ) inches in height, and one (1″) inch in width.

12. The leveling device of claim 1 and further comprising:
a magnetic strip secured to either the top surface or the bottom surface of the tool.

13. A method for providing a hands free means of determining measurements and leveling standards, the method comprising:
providing an elongated tool having a first end, a second end opposite the first end, a top surface, and a bottom surface opposite the top surface;
mounting at least one bubble level to the elongated tool;
mounting a plurality of independently activatable, spring-loaded leveling buttons in the bottom surface of the tool and flush with the bottom surface of the tool;
releasing the leveling buttons from a retracted position into an extended position; and
extending each leveling button a unique predetermined distance from the bottom surface of the tool.

14. A leveling device providing a hands free means of determining measurements and leveling standards, the leveling device comprising:
an elongated tool having a first end, a second end opposite the first end, a top surface, and a bottom surface opposite the top surface;
three bubble levels mounted to the elongated tool, each bubble level measuring a different level angle; and
a plurality of independently activatable, spring-loaded leveling buttons mounted in the bottom surface of the tool;
wherein upon being in a retracted position, each of the leveling buttons is flush with the bottom surface of the tool;
wherein each of the leveling buttons is released upon applying pressure to each leveling button;
wherein each of the leveling buttons is returned to the retracted position upon applying pressure to each released leveling button; and
wherein upon being released from the retracted position into an extended position, each leveling button extends a unique predetermined distance from the bottom surface of the tool.

15. The leveling device of claim 14 and further comprising:
a first bubble level mounted adjacent the first end of the tool;
a second bubble level mounted adjacent the second end of the tool; and
a third bubble level mounted in the middle of the tool approximately equal distance between the first end and the second end of the tool.

16. The leveling device of claim 15 wherein the first bubble level is a forty-five degree level, the second bubble level is a vertical level, and the third bubble level is a horizontal bubble level.

17. The leveling device of claim 14 and further comprising:
three (3) first end leveling buttons mounted nearingly adjacent the first end of the tool; and
three (3) second end leveling buttons mounted nearingly adjacent the second end of the tool.

18. The leveling device of claim 17 wherein upon releasing the first end leveling buttons into the extended position, the three (3) first end leveling buttons adjacent the first end of the tool have a length of one-eighth (⅛″ ) inch, one-quarter (¼″ ) inch, and one-half (½″ ) inch, respectively.

19. The leveling device of claim 18 wherein upon releasing the second end leveling buttons into the extended position, the three (3) second end leveling buttons adjacent the second end of the tool have a length of three-sixteenths ( 3/16″ ) inch, five-sixteenths ( 5/16″ ) inch, and seven-sixteenths ( 7/16″ ) inch, respectively.

20. The leveling device of claim 14 and further comprising:
a magnetic strip secured to either the top surface or the bottom surface of the tool.
